(19) United States
(12) Patent Application Publication
(10) Pub. No.: US 2004/0055524 A1
(43) Pub. Date: Mar. 25, 2004

(54) Wind-indicator with lighting device

(75) Inventor: Kuei-Hua Lin, Taichung Hsien (TW)

Correspondence Address: BACON & THOMAS, PLLC, 625 SLATERS LANE, FOURTH FLOOR, ALEXANDRIA, VA, 22314

(73) Assignee: Kok Han Industrial Co., Ltd., Taichung City (TW)

(21) Appl. No.: 10/251,766

(22) Filed: Sep. 23, 2002

(51) Int. Cl. G01F 15/00

(52) U.S. Cl. 116/264

(57) ABSTRACT

An improved wind-indicator with lighting device comprises a blade body, a front cap, a permanent-magnet, a wire seat, a rear cover, two axle bearings, an axle, a mounting body, a fixing post, two washers, and a bolt nut wherein said blade body is provided with a multiple of blades with lighting members disposed thereon. A wire coil encircling the external periphery of said wire seat thereof provides electrical wires to conduct electricity to the interior of axle bearings from which said electrical wires are further extended to connect with said lighting members to form an electrical circuit. When said blades thereof moved by wind, said blade body will pivotally rotate via said axle thereof, causing the rotation of the wire coil therewith which, interacting with the magnetic pole of said permanent-magnet, will cut through the magnetic line of force thereof to generate electrical current for the lightening of said lighting members thereof for variety of said wind-indicator thereof. In addition, the present invention can also be adapted to a handle-bar of a bicycle and fixedly secure thereto via a pair of fixing covers; otherwise, said mounting body thereof can also be replaced by a handle so that the present invention thereof can be easily grasped by human hands. In one more case, a permanent-magnet can also be sleeve joined to a wire coil encircling the internal periphery of a wire seat for lightening thereof.

### BACKGROUND OF THE INVENTION

The present invention is related to an improved wind-indicator with lighting device, comprising a blade body, a front cap, a permanent-magnet, a wire seat, a rear cover, two axle bearings, an axle, a mounting body, a fixing post, two washers, and a bolt nut wherein said blade body is provided with a multiple of blades with lighting members disposed thereon. When said blades moved by wind, said blade body will pivotally rotate via said axle, causing said wire seat to rotate therewith and interact with said permanent-magnet thereof to generate electrical current. Electrical wires are adapted to conduct the electricity generated to the interior of said axle bearings from which said electrical wires are further extended to connect with said lighting members, forming an electrical circuit for the lightening of said lighting members.

Please refer to FIG. 1. A conventional wind-indicator as shown in the weathercock of FIG. 1 is mainly made up of a weathercock 1, and a fixing post 2. Said weathercock 1 is provided with a mounting tube 11 to be sleeve joined to said mounting tube 11 and fixed thereto via a hook member 13 inserted to a clamping groove 111 thereof. When moved by wind, said weathercock 1 can only rotate for indication of the wind without any variety in function and design.

### SUMMARY OF THE PRESENT INVENTION

It is, therefore, the primary purpose of the present invention to provide a wind-indicator with lighting device, comprising mainly a blade body, a front cap, a permanent-magnet, a wire seat, a rear cover, two axle bearings, an axle, a mounting body, a fixing post, two washers, and a bolt nut wherein said blade body is provided with a multiple of blades with lighting members disposed thereon. When said blades moved by wind, said blade body will pivotally rotate via said axle, causing said wire seat to rotate therewith and interact with the magnetic pole of said permanent-magnet thereof to generate electrical current. Electrical wires are adapted to conduct the electricity generated to the interior of said axle bearings from which said electrical wires are further extended to connect with said lighting members, forming an electrical circuit for the lightening of said lighting members, increasing the variety of said wind-indicator thereof in use and design.

### BRIEF DESCRIPTION OF THE DRAWINGS

FIG. 1 is a perspective exploded view of a conventional wind-indicator.

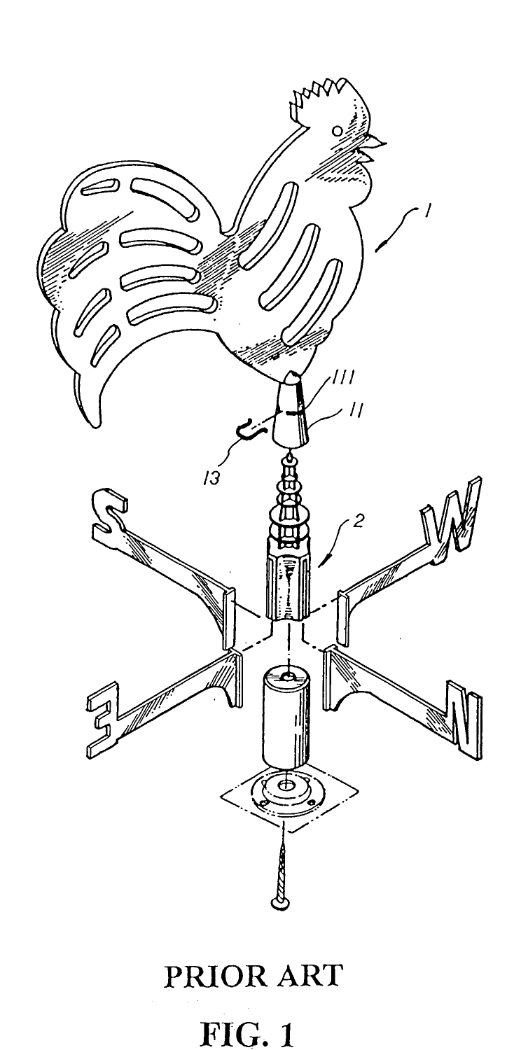

FIG. 2 is a perspective exploded view of the present invention.

FIG. 3 is a perspective view of the present invention in assembly.

FIG. 4 is a sectional view of the present invention in assembly.

FIG. 5 is a perspective view of another embodiment of the present invention.

FIG. 6 is a perspective view of a third embodiment of the present invention.

FIG. 7 is a perspective exploded view of a fourth embodiment of the present invention.

FIG. 8 is a sectional view of said fourth embodiment of the present invention in assembly.

### DETAILED DESCRIPTION OF THE PREFERRED EMBODIMENTS

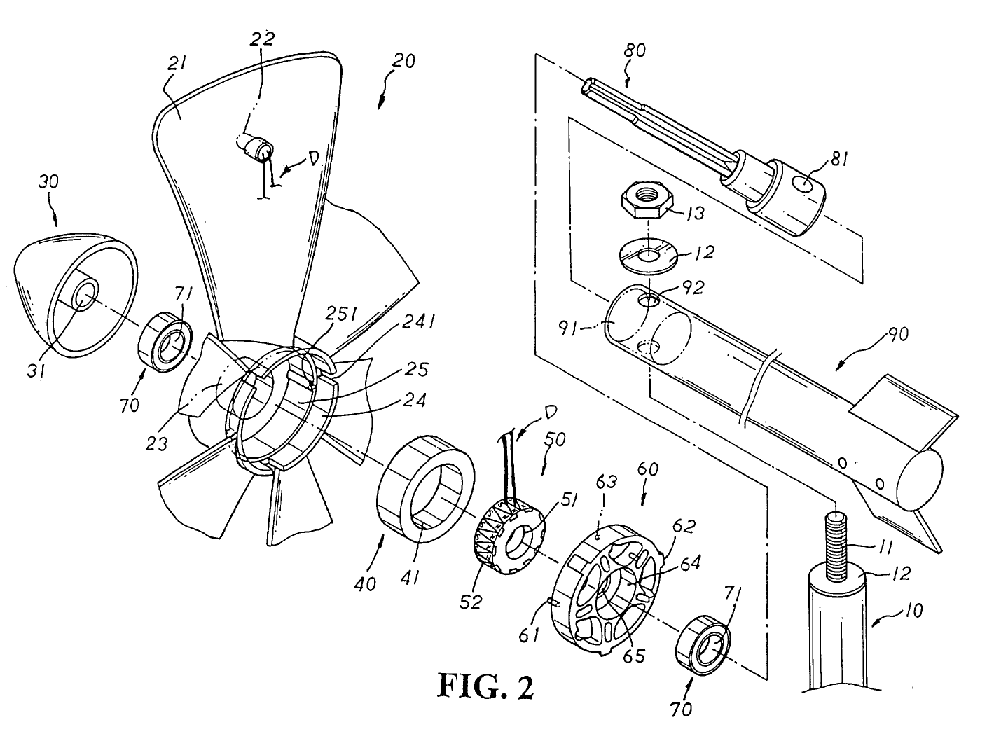

Please refer to FIG. 2. The present invention is related to an improved wind-indicator with lighting device, comprising a blade body 20, a front cap 30, a permanent-magnet 40, a wire seat 50, a rear cover 60, two axle bearings 70, an axle 80, a mounting body 90, a fixing post 10, two washers 12, and a bolt nut 13.

Said blade body 20 is provided with a multiple of blades 21 with lighting members 22 disposed thereon, an indented central groove 23 disposed at the front thereof for the first of said two axle bearings 70 to be adapted therein, and a large and a small staged coupling grooves 24, 25 disposed at the rear thereof with a passage 26 disposed at the center thereof communicating said large and small staged coupling grooves 24, 25 with said indented central groove 23 thereof. Said small staged coupling groove 25 is equipped with a multiple of inserting slots 251 distributed at the inner periphery thereof, and said large staged coupling groove 24 includes a multiple of locating recesses 241 defining the peripheral edge thereof. Said front cap 30 has a hollow column 31 disposed at the inner side thereof; said permanent-magnet 40 is provided with a through hole 41 disposed at the center thereof. Said wire seat 50 is ring-shaped with a slot 51 disposed at the center thereof and a wire coil 52 encircling the external periphery thereof. Said rear cover 60 is provided with a multiple of projecting blocks 61 disposed at the front side thereof, a multiple of projecting flanges 62 and ports 63 disposed at the outer periphery thereof, an indented receiving groove 64 disposed at the center of the rear side thereof for the second of said axle bearings 70 to be adapted therein, and a hole 65 passed through the center thereof. Each of said axle bearings 70 has an axle hole 71 disposed at the center thereon. Said axle 80 has a staged rod of proper length extending at the front end thereof, and a longitudinal connecting hole 81 disposed at the rear end thereof. Said mounting body 90 is equipped with a fixing groove 91 disposed at the front end thereof, and a longitudinal fixing hole 92 disposed at the middle section of said fixing groove 91 thereof, matching to the longitudinal connecting hole 81 of said axle 80 thereof.

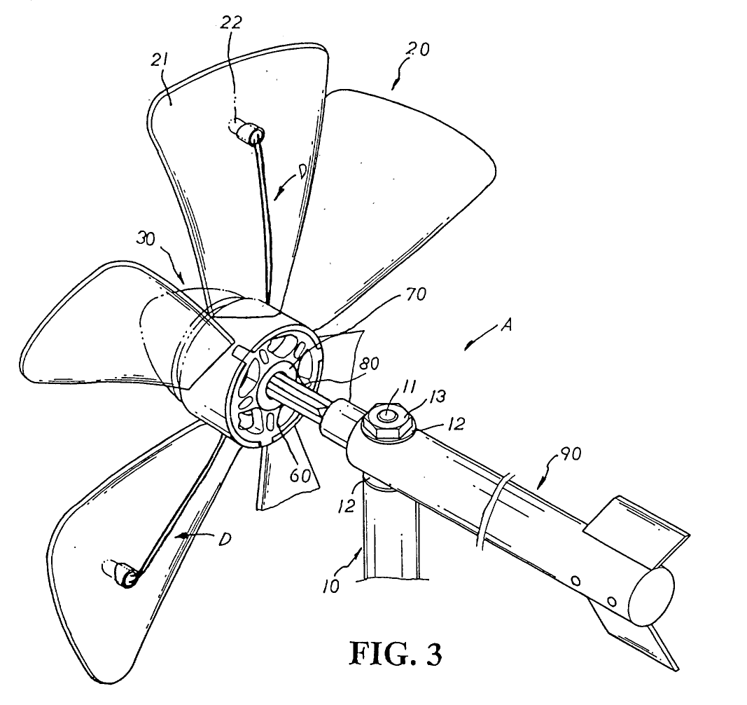

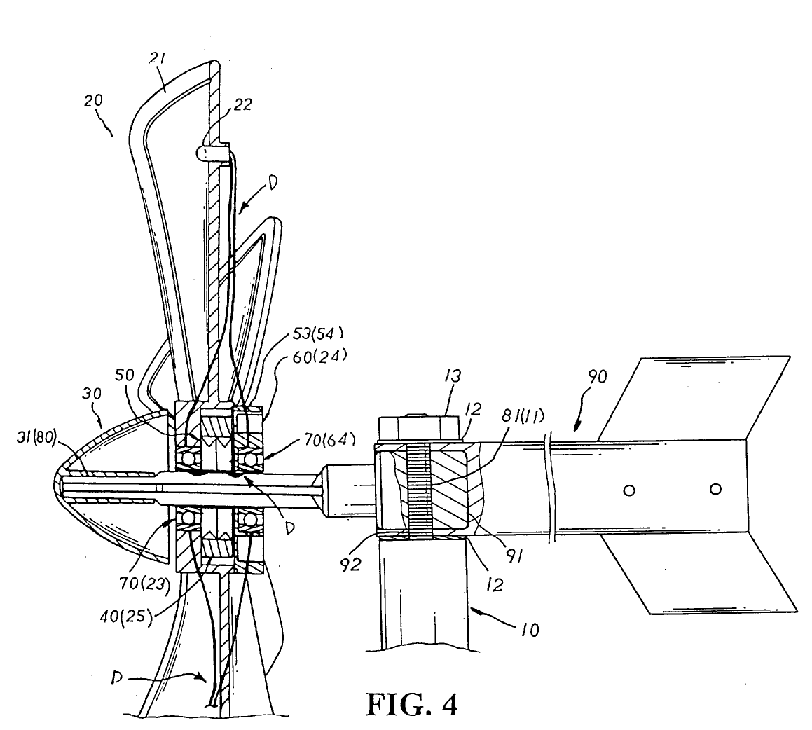

Please refer to FIGS. 3, 4. In assembly, said permanent-magnet 40 is sleeve joined to said wire seat 50 with said wire coil 52 thereof located at the through hole 41 of said permanent-magnet 40 thereof. The assembled permanent-magnet 40 and wire seat 50 are then adapted to the small-staged coupling groove 25 disposed at the rear of said blade body 20. Said rear cover 60 is then adapted to the large-staged coupling groove 24 of said blade body 20 with said projecting blocks 61 thereof joined to the inserting slots 251 thereof and said projecting flanges 62 thereof engaged with said locating slots 241 thereof for secure engagement thereof. Said wire coil 52 thereof provides electrical wires D to conduct electricity to the interior of said axle bearings 70 from which said electrical wires D can be further extended out of the ports 63 of said rear cover 60 to be connected with the lighting members 22 of said blades 21 thereof. Said wires D pulled out of said wire seat 50 form an electrical circuit to provide power necessary for the lightening of said light members 22 thereof to complete the assembly of the blade body 20 thereof. Said axle 80 led through the assembled blade body 20 is fixedly inserted to the hollow column 31 of said front cap 30 at the front end thereof, and sleeve joined to the fixing groove 91 of said mounting body 90 at the rear end thereof. Said fixing post 10 is provided with outer threads 11 of smaller diameter disposed at the upper section thereof which with the first washer 12 applied thereon is led through the longitudinal fixing hole 92 of said mounting body 90 and the longitudinal connecting hole 81 disposed at the rear end of said axle 80 and then securely fixed thereto via said second washer 12 and said bolt nut 13 to complete the assembly of the present invention.

In practical use, when said blades 21 thereof moved by wind, said blade body 20 will pivotally rotate via said axle 80 thereof, causing the rotation of the wire coil 52 of said wire seat 50 therewith. The rotating wire coil 52 thereof will interact with the magnetic pole of said permanent-magnet 40, cutting through the magnetic line of force thereof to generate electrical current for lightening. Said electrical wires D pulled from said wire coil 52 thereof will conduct the electricity generated to the interior of said axle bearings 70 from which said electrical wires D are further extended and connected with said lighting members 22, forming an electrical circuit with negative and positive poles for the lightening of said lighting members 22 thereof for variety of said wind-indicator.

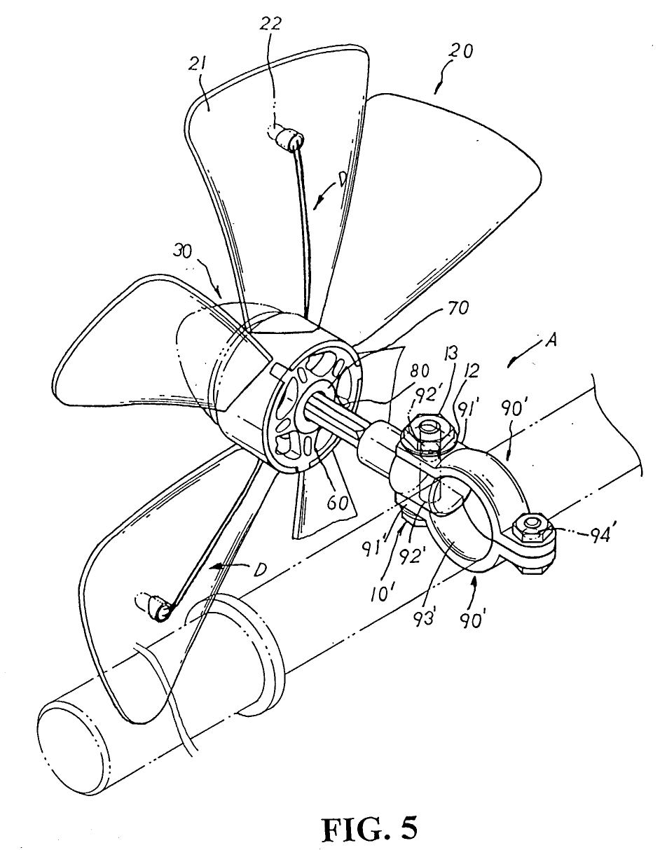

Please refer to FIG. 5, showing another embodiment of the present invention. Said wind-indicator with lighting device of the present invention can also be adapted to a handle-bar of a bicycle and securely fixed thereto via a pair of fixing covers 90′. Said fixing covers 90′ are equipped with a pair of clamping plates 91′ disposed at one side thereof with fixing slots 92′ disposed thereon, a pair of arc coupling parts 93′ disposed at the middle section thereof with a through hole 94′ defined there-between, and fixing holes 94′ disposed at the other sides thereof. In assembly, said fixing covers 90′ are mounted to the handlebar of a bicycle via said arc coupling parts 93′ and fixed thereto via a bolt led through said fixing holes 94′ thereof and screwed up by a nut. Said axle 80 thereof assembled with said blade body 20 and front cap 30 at the front end thereof is sandwiched by the clamping plates 91′ of said fixing covers 90′ at the rear end thereof. A screw bolt 10′ with the first washer 12 applied thereon is adapted to pass through the fixing slots 92′ of said fixing covers 90′ and the longitudinal connecting holes 81 of said axle 80 and securely fixed thereto via the second washer 12 and the bolt nut 13 to complete the assembly as shown in FIG. 5.

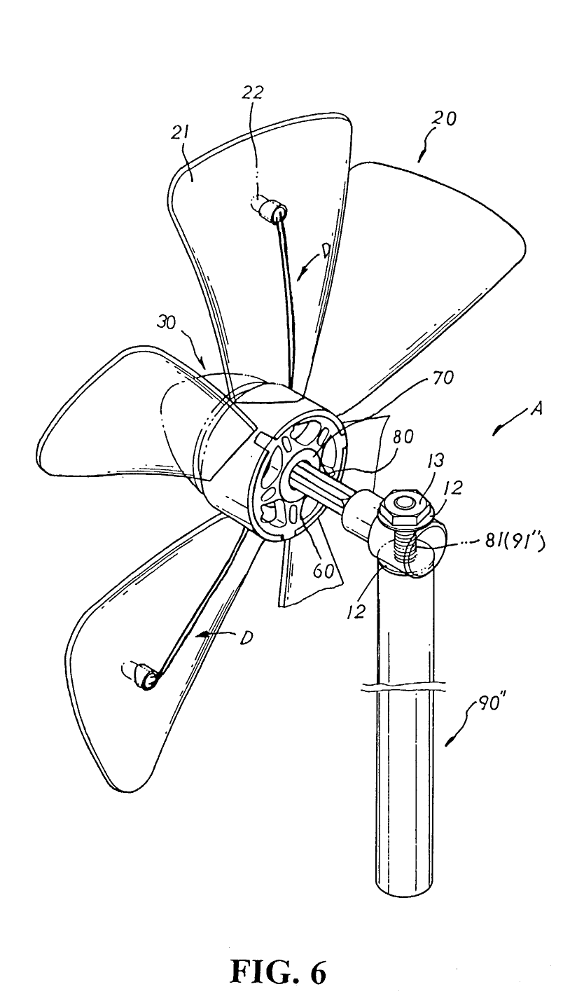

Please refer to FIG. 6, showing a third embodiment of the present invention. Said mounting body 90 can also be replaced by a handle 90″ so that said wind-indicator with lighting device of the present invention can be easily grasped by human hands. Said handle 90″ is provided with outer threads 91″ of smaller diameter disposed at the upper section thereof to which said axle 80 assembled to said blade body 20 and said front cap 30 thereof at the front end thereof can be securely fixed at the rear end thereof. The outer threads 91″ of said handle 90″ having the first washer 12 applied thereon is led through the longitudinal connecting hole 81 of said axle 80 and fixedly secured thereto via the second washer 12 and said bolt nut 13 thereof to complete the assembly of the present invention as shown in FIG. 6.

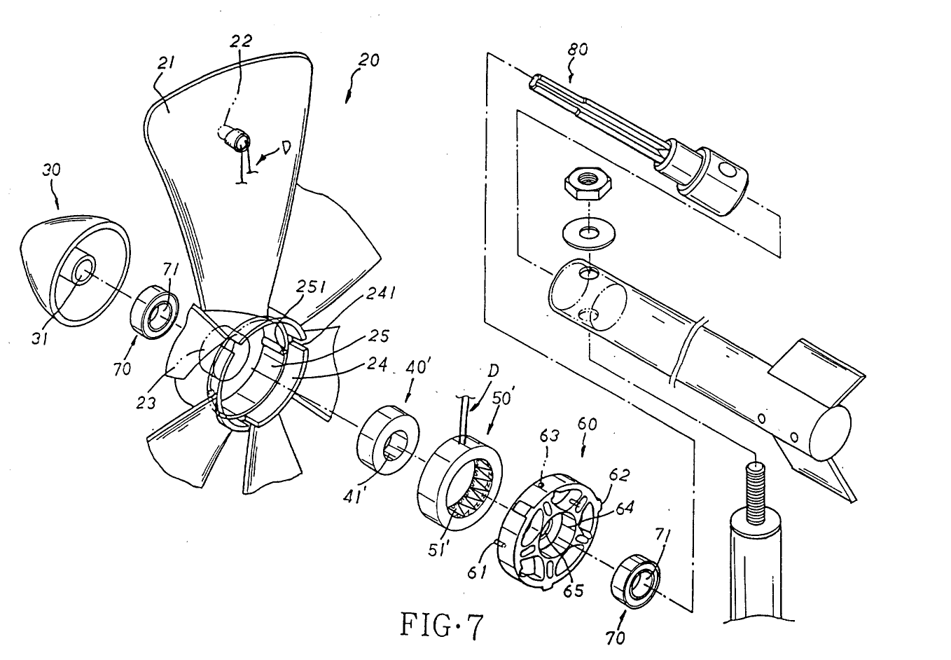

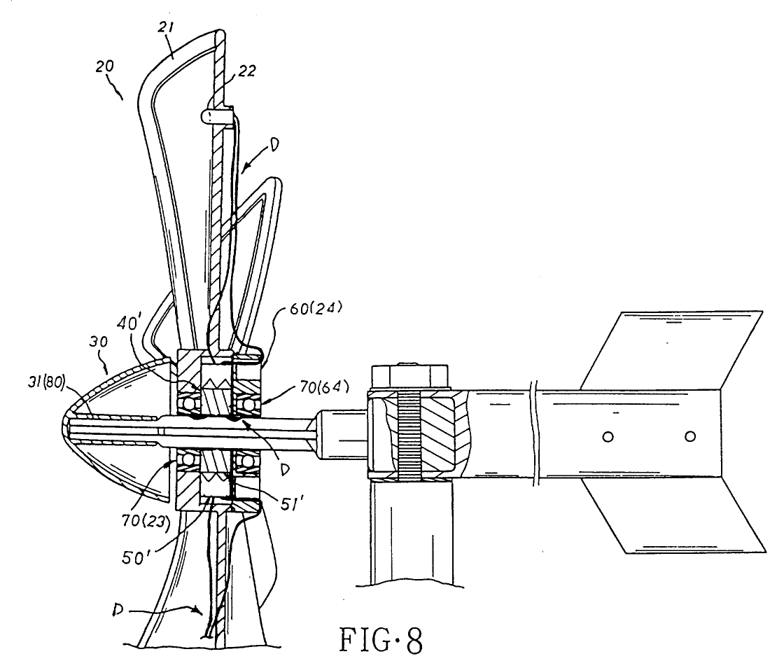

Please refer to FIG. 7 showing a fourth embodiment of the present invention. Said fourth embodiment of the present invention mainly includes a blade body 20, a front cap 30, a permanent-magnet 40′, a wire seat 50′, a rear cover 60, two axle bearings 70, an axle 80, a mounting body 90, a fixing post 10, two washers 12, and a bolt nut 13 wherein said permanent-magnet 40′ has a through hole 41′ disposed at the center thereof, and said wire seat 50′ is ring-shaped with a slot disposed at the center and a wire coil 51′ encircling the internal periphery thereof. In assembly, said permanent-magnet 40′ is located at the slot of said wire seat 50 and sleeve joined to the wire coil 51′ disposed at the internal periphery of said wire seat 50′ thereof. Said wire seat 50′ with said permanent-magnet 40′ joined thereto is then adapted to the small-staged coupling groove 25 disposed at the rear of said blade body 20, and said rear cover 60 is then adapted to the large-staged coupling groove 24 of said blade body 20 thereof. Electrical wires D are extended from said wire coil 51 thereof, coming out of the ports 63 of said rear cover 60 to be connected with the lighting members 22 of said blades 21 thereof to form an electrical circuit for lightening. Said axle 80 is then led through the blade body 20 and fixedly inserted to said front cap 30 at the front end thereof, and joined to said mounting body 90 and said fixing post 10 at the rear end thereof to complete the assembly as shown in FIG. 8.

In practical use, when said blades 21 of the fourth embodiment thereof moved by wind, said blade body 20 will pivotally rotate via said axle 80 thereof, causing the rotation of said permanent-magnet 40′ therewith. The wire coil 51′ of said wire seat 50′, interacting with the rotating permanent-magnet 40′ thereof, will cut through the magnetic line of force thereof to generate electrical current for lightening. Said electrical wires D pulled from said wire coil 52 thereof will conduct the electricity generated to said lighting members 22, forming an electrical circuit with negative and positive poles for the lightening of said lighting members 22 thereof for variety of said wind-indicator.

What is claimed is:

1. An improved wind-indicator with lighting device, comprising a blade body, a front cap, a permanent-magnet, a wire seat, a rear cover, two axle bearings, an axle, a mounting body, a fixing post, two washers, and a bolt nut wherein said blade body is provided with a multiple of blades with lighting members disposed thereon; said wind-indicator with lighting device characterized by that;
said blade body also including an indented central groove disposed at the front thereof for the first of said two axle bearings to be adapted therein, and a large and a small staged coupling grooves disposed at the rear thereof with a passage disposed at the center thereof; said small staged coupling groove having a multiple of inserting slots distributed at the inner periphery thereof, and said large staged coupling groove a multiple of locating recesses defining the peripheral edge thereof;
said front cap having a hollow column disposed at the inner side thereof;
said permanent-magnet, having a through hole disposed at the center thereof, is adapted to the small staged coupling groove of said blade body; said wire seat, ring-shaped with a slot disposed at the center thereof and a wire coil encircling the external periphery thereof, is sleeve joined to the through hole of said permanent-magnet;
said rear cover, having a multiple of projecting blocks disposed at the front side thereof, a multiple of projecting flanges and ports disposed at the outer periphery thereof, an indented receiving groove disposed at the center of the rear side thereof for the second of said axle bearings to be adapted therein, and a hole passed through the center thereof, is securely engaged with the large coupling groove of said blade body thereof;
each of said axle bearings having an axle hole disposed at the center thereon;
said axle, having a staged rod of proper length extending at the front end thereof and a longitudinal connecting hole disposed at the rear end thereof matching to a longitudinal fixing hole of a fixing groove disposed at the front end of said mounting body, is led through said assembled blade body and joined to said front cap thereof at the front end thereof, and fixedly secure to said mounting body and fixing post via said washers and said bolt nut to complete the assembly thereof;
whereby, said wire coil thereof provides electrical wires D to conduct electricity to the interior of said axle bearings from which said electrical wires D can be further extended out of the ports of said rear cover, connecting with the lighting members thereof to form an electrical circuit; when said blades thereof moved by wind, said blade body will pivotally rotate via said axle thereof, causing the rotation of the wire coil therewith which, interacting with the magnetic pole of said permanent magnet, will cut through the magnetic line of force thereof to generate electrical current for the lightening of said lighting members thereof for variety of said wind-indicator thereof.

2. The improved wind-indicator with lighting device as claimed in claim 1 wherein said wind-indicator with lighting device of the present invention can also be adapted to a handle-bar of a bicycle and securely fixed thereto via a pair of fixing covers; said fixing covers, having a pair of clamping plates and fixing slots disposed at one side thereon, a pair of arc coupling parts and a through hole defined there-between disposed at the middle section thereof, and fixing holes disposed at the other sides thereof, is mounted to the handlebar of a bicycle via said arc coupling parts and fixed thereto via a bolt led through said fixing holes thereof and screwed up by a nut; said axle thereof, joined to said assembled blade body and front cap at the front end thereof, is sandwiched by said clamping plates thereof at the rear end thereof; a screw bolt with the first washer applied thereon is adapted to pass through said fixing slots thereof and the longitudinal connecting holes of said axle, and securely fix thereto via the second washer and the bolt nut to complete the assembly thereof.

3. an improved wind-indicator with lighting device as claimed in claim 1 wherein said mounting body can also be replaced by a handle for the grasp of human hands; said handle is equipped with outer threads of smaller diameter disposed at the upper section thereof to which said axle thereof can be securely fixed at the rear end thereof; said outer threads thereof with the first washer applied thereon being led through the longitudinal connecting hole of said axle and fixedly secured thereto by the second washer and said bolt nut thereof to complete the assembly thereof.

4. an improved wind-indicator with lighting device as claimed in claim 1 wherein a permanent-magnet, having a through hole disposed at the center thereof, can also be located at a slot disposed at the center of a wire seat and sleeve joined to a wire coil encircling the internal periphery of said wire seat; whereby, when said blades thereof moved by wind, said blade body will pivotally rotate via said axle thereof, causing the rotation of said permanent-magnet therewith and the interaction of said permanent-magnet with said wire coil thereof which will cut through the magnetic line of force thereof to generate electrical current for lightening of said wind-indicator with lighting device.
